(19) United States
(12) Patent Application Publication
(10) Pub. No.: US 2008/0010672 A1
(43) Pub. Date: Jan. 10, 2008

(54) SEGREGATED COMMUNICATION SYSTEM AND METHOD FOR COMPARTMENTALIZED MANAGEMENT OF COMMUNICATION SERVICES

(75) Inventor: Andrew W. Buffmire, Issaquah, WA (US)

Correspondence Address: DAVIS WRIGHT TREMAINE, LLP/Seattle, 1201 Third Avenue, Suite 2200, SEATTLE, WA, 98101-3045, US

(73) Assignee: STRATA8 NETWORK, INC., MERCER ISLAND, WA (US)

(21) Appl. No.: 11/697,649

(22) Filed: Apr. 6, 2007

Related U.S. Application Data
(60) Provisional application No. 60/744,399, filed on Apr. 6, 2006.

(51) Int. Cl. H04L 9/32

(52) U.S. Cl. 726/4; 726/3

(57) ABSTRACT

A home location register includes a plurality of number profiles, portions of which are segregated into a first number set and a second number set. Portions of a plurality of server applications are segregated into a first application set and a second application set. A first user is allowed access to the first application set and prevented access to the second application set. A second user is allowed access to the second application set and prevented access to the first application set. Association is maintained between the first number set and the first application set. Association is prevented between the first number set and the second application set. Association is maintained between the second number set and the second application set. Association is prevented between the second number set and the first application set.

### BACKGROUND OF THE INVENTION

1. Field of the Invention

The present invention is directed generally to communication systems.

2. Description of the Related Art

Historically electronic voice communications occurred over circuit switched telephone networks connected as part of the public switched telephone network (PSTN). Certain significant barriers to entry existed for new participants that would seek to provide electronic voice communications to individuals or enterprises into and over the PSTN. These included, significantly, the requirement of substantial amounts of capital to build large circuit switched telephone networks including, in particular, “last mile” connectivity and regulatory barriers to entry.

Commencing in the mid 1990's the internet became a significant path for delivery of data to end-users and has evolved in connectivity penetration and data capacity to the point where it effectively allows for voice services to be delivered via internet protocol over data network, known as voice over IP (VoIP) to end users. In addition to the foregoing, multiple wireless networks have been deployed since the 1980's providing for end-user voice connectivity over an air interface using analogue or digitized transmission protocols. More recently existing wireless networks have been modified or new networks deployed to provide for high-speed data transmission allowing for VoIP services to be delivered over wireless data enabled networks.

These networks are interconnected using common protocols and are connected to the PSTN to provide voice communications between all end-users. As the networks have evolved, additional data related services have been added to simple voice communication. These have initially included voice control features such as call waiting, voice mail, call forwarding and others and have more recently evolved to features such as, for example, voice activated dialing, interactive voice response capabilities and integrated location based services for wireless networks.

As each of these service platforms have evolved the carriers of services have sought to restrict the provisioning of integrated services over their respective networks or to create “walled gardens” that control and limit access by third parties to the development and control of integrated voice and data services for delivery over wireless, wire line and data networks.

### BRIEF DESCRIPTION OF THE SEVERAL VIEWS OF THE DRAWING(S)

FIG. 1 is a schematic block diagram of a computer and associated equipment that is used with implementations of the system.

FIG. 2 is a schematic block diagram of elements of the system.

FIG. 3 is a schematic block diagram of a compartmentalized communication exchange and associated segregated application servers.

FIG. 4 is a schematic block diagram of an implementation of the system for remote carrier selection.

FIG. 5 is a schematic block diagram of handsets and a carrier management system associated with the remote carrier selection implementation of FIG. 4.

FIG. 6 is a schematic block diagram of an implementation of the system for exchange based control of handset access of data and/or services.

FIG. 7 is a schematic block diagram of an implementation of the system depicting disaggregation of switching and media.

### DETAILED DESCRIPTION OF THE INVENTION

As will be discussed in greater detail herein, a segregated communication system and method is used for compartmentalized management of communication services. Some implementations provide availability for an open carrier platform for third party call control and control of data applications and services over wireless, wire line and Internet protocol networks with, in addition, a dedicated channel for wireless call control. Other implementations provide availability for an open platform providing for non-carrier voice and data transmission path control including call control over a carrier switch of voice delivery and data delivery along with voice platform integration and delivery of on-demand services, software as a service and integrated applications and services over wireless, wire line and IP networks.

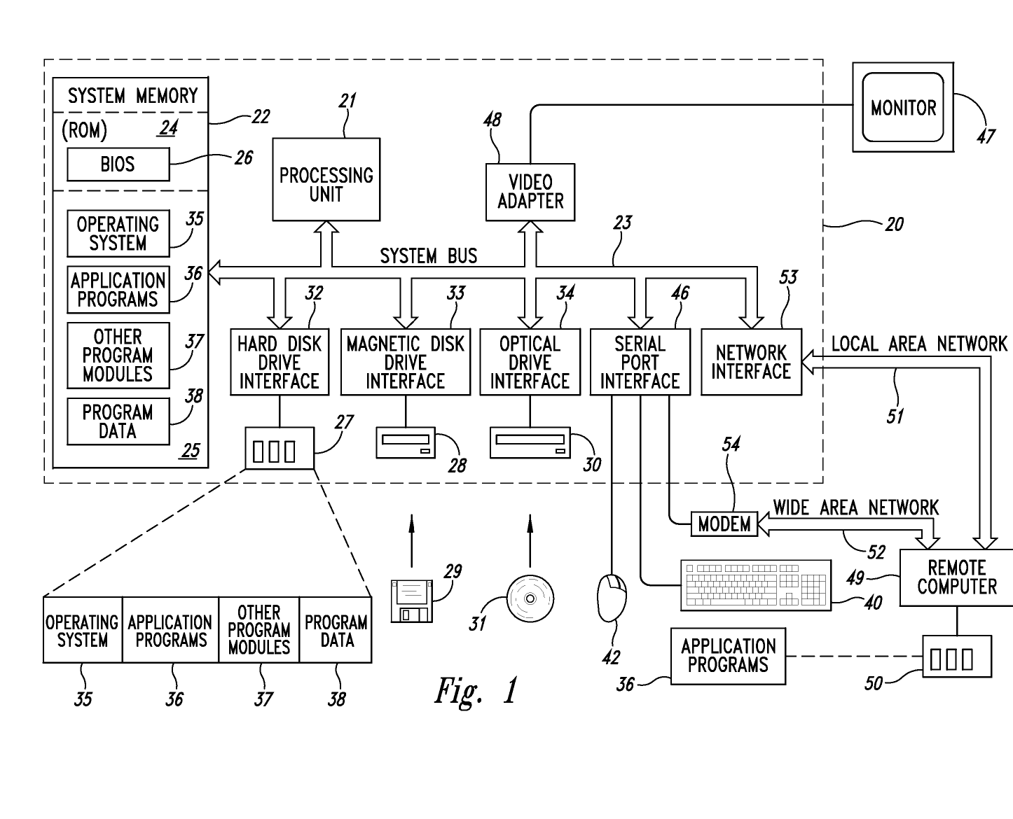

FIG. 1 is a diagram of a hardware and operating environment in conjunction with which at least portions of implementations may be practiced. The description of FIG. 1 is intended to provide a brief, general description of suitable computer hardware and a suitable computing environment in which implementations may be practiced. Although not required, at least portions of implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 1 includes a general purpose computing device in the form of a computer 20, including a processing unit 21, a system memory 22, and a system bus 23 that operatively couples various system components, including the system memory 22, to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer.

The system bus 23 may be any of several types of bus structures including a memory bus or memory controller, a peripheral bus, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, may be used in the exemplary operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20, the local computer; implementations are not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 1. The logical connections depicted in FIG. 1 include a local-area network (LAN) 51 and a wide-area network (WAN) 52. Such networking environments are commonplace in offices, enterprise-wide computer networks, intranets and the Internet.

When used in a LAN-networking environment, the computer 20 is connected to the local network 51 through a network interface or adapter 53, which is one type of communications device. When used in a WAN-networking environment, the computer 20 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computer 20, or portions thereof, may be stored in the remote memory storage device. It is appreciated that the network connections shown are exemplary and other means of and communications devices for establishing a communications link between the computers may be used.

The hardware and operating environment in conjunction with implementations that may be practiced has been described. The computer in conjunction with implementation that may be practiced may be a conventional computer, a distributed computer, or any other type of computer. Such a computer typically includes one or more processing units as its processor, and a computer-readable medium such as a memory. The computer may also include a communications device such as a network adapter or a modem, so that it is able to communicatively couple to other computers.

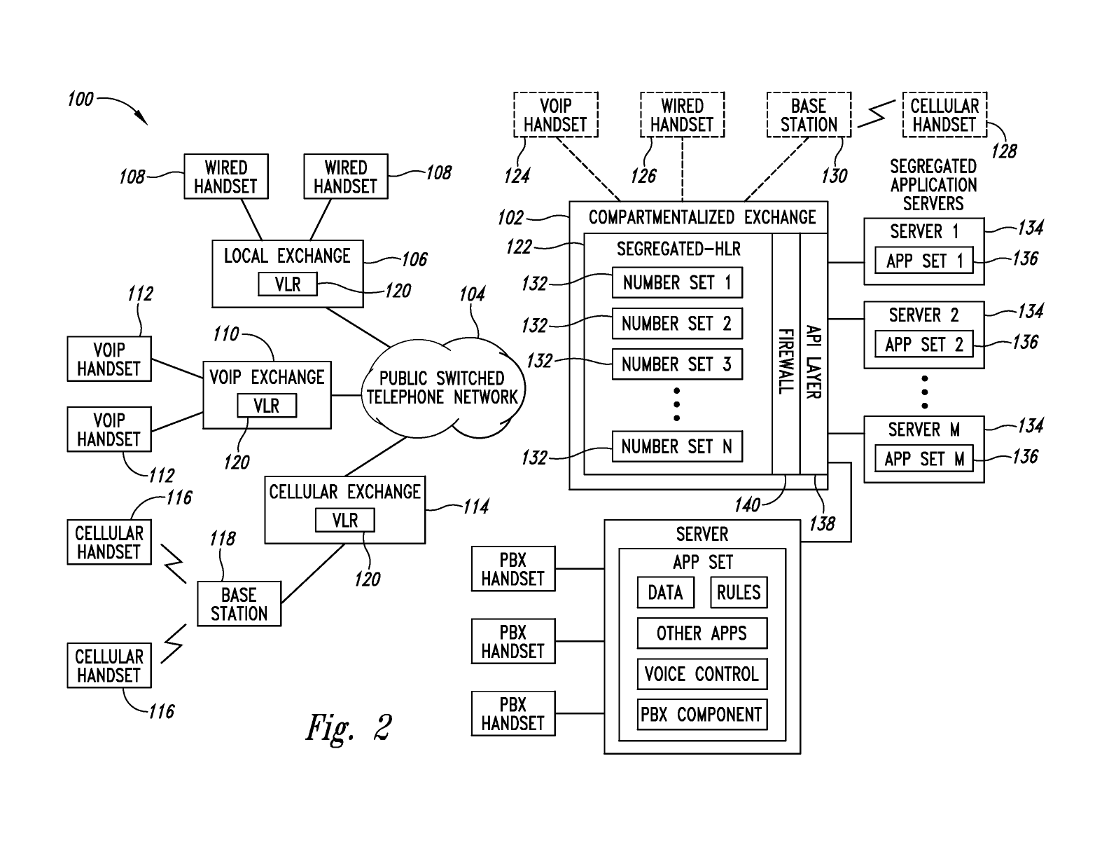

As shown in FIG. 2, a depicted implementation 100 of a segregated communication system includes a compartmentalized exchange 102 communicatively linked with a public switched telephone network (PSTN) 104. Other exchanges including a local exchange 106 servicing wired handsets 108, a voice over internet protocol (VoIP) exchange 110 servicing VoIP handsets 112, and a cellular exchange 114 servicing cellular handsets 116 through a base station 118 are also depicted as being communicatively linked with the PSTN 104. The local exchange 106, the VoIP exchange 110, and the cellular exchange 114, have virtual location registers (VLR) 120, which are used with a segregated home location register (HLR) 122 of the compartmentalized exchange to assist with establishing communication.

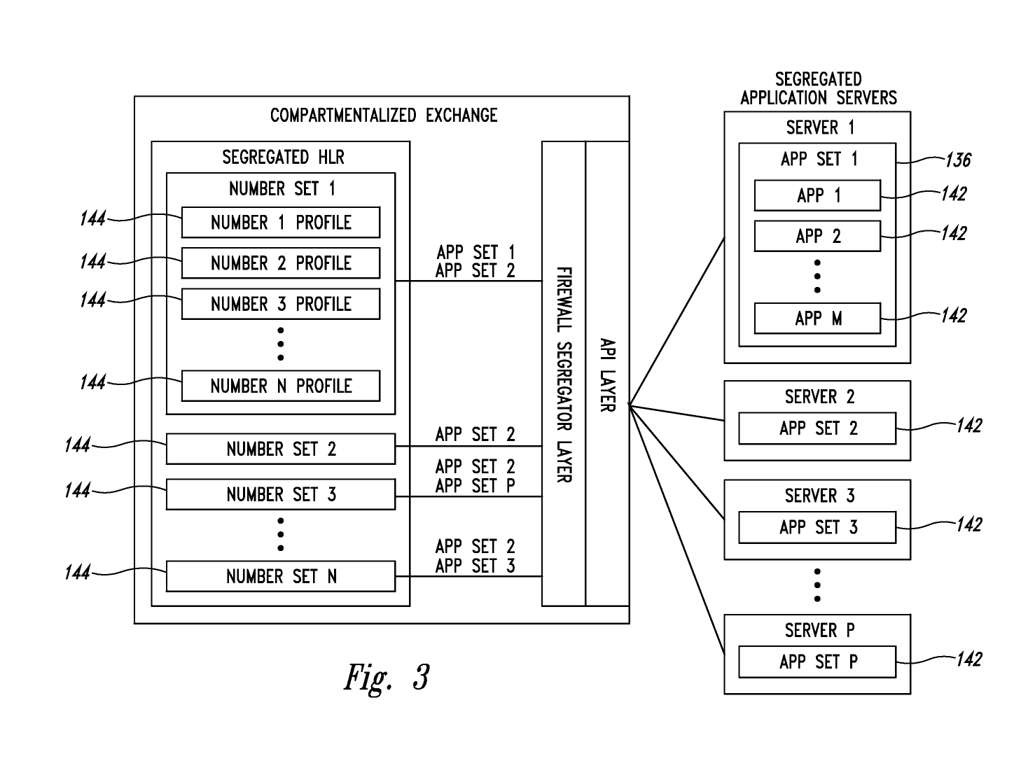

The compartmentalized exchange 102 in shown communicatively linked to a VoIP handset 124, a wired handset 126, and a cellular handset 128 through a base station 130, which are all depicted in dashed line to denote that typically in practice just one type of the three handsets shown would be directly linked to the compartmentalized exchange. The segregated HLR 122 contains a plurality of number sets 132 that are shown to be isolated from one another. A plurality of segregated application servers 134 are shown to be isolated from another and to each contain a separate application set 136. Each of the plurality of segregated application servers 134 is communicatively linked to one or more of the number sets 132 through an application program interface (API) layer 138 and a firewall segregator layer 140 better shown in FIG. 3.

Each of the plurality of segregated application servers 134 is communicatively linked to the compartmentalized exchange through one or more APIs of the API layer 138. The application sets 142 each contain one or more applications. The number sets 132 each contain one or more number profiles 144. Each of the number profiles 144 can contain authorization, authentication, privileges, responsibilities, rights, user identification, handset identification (such as the phone number of the handset) and other information related to use of networks such as the PSTN network and related services such as those contained with one or more of the application sets 142.

The firewall segregator layer 140 associates each of the application sets 136 with one or more, but typically not all, of the number sets 132. Through these associations the firewall segregator layer 142 controls access by each of the application sets 136 and consequently their applications 142 contained therein to the number sets 132 and consequently their number profiles 144 contained therein. In some implementations, management for each of the number sets 132 and the information contained in each of the number profiles 144 of the number set is done through one or more of the applications 142 of the application set 136 that is associated with the number set. Since each of the application sets 136 are typically associated with different number sets 132, each of the number sets can be managed by different ones of the application sets.

Each of the application sets 136 are depicted as running on different ones of the application servers 134 so that management privileges for various ones of the application sets 136 and consequently different ones of the number sets 144 can be allocated to different application server users. In the exemplary implementation of FIG. 3, application set 1 and application set 2 are depicted as being associated with the number set 1, application set 2 is depicted as being associated with number set 2, application set 2 and application set P are depicted as being associated with number set 3, and application set 2 and application set 3 are depicted as being associated with number set N.

As a result of the firewall segregator layer 140, various third parties can manage various ones of the number sets without being directly affiliated with a company that has retained the overall rights and responsibilities for the compartmentalized exchange 102. For instance, in the illustrated example, the company having overall rights to the compartmentalized exchange may still be able to exercise certain policies pertaining to all of the number sets 144 such as by having the application set 2 being associated with all of the number sets shown. On the other hand, third parties could manage other aspects of the number sets 144 through separate of the application sets 136, for instance, as depicted by application set 1 being associated with number set 1, application set P being associated with number set 3, and application set 3 being associated with number set N as shown in FIG. 3. In other implementations the application sets can reside on fewer servers so that security measures found with the operating system of the servers may be used for segregation of application sets.

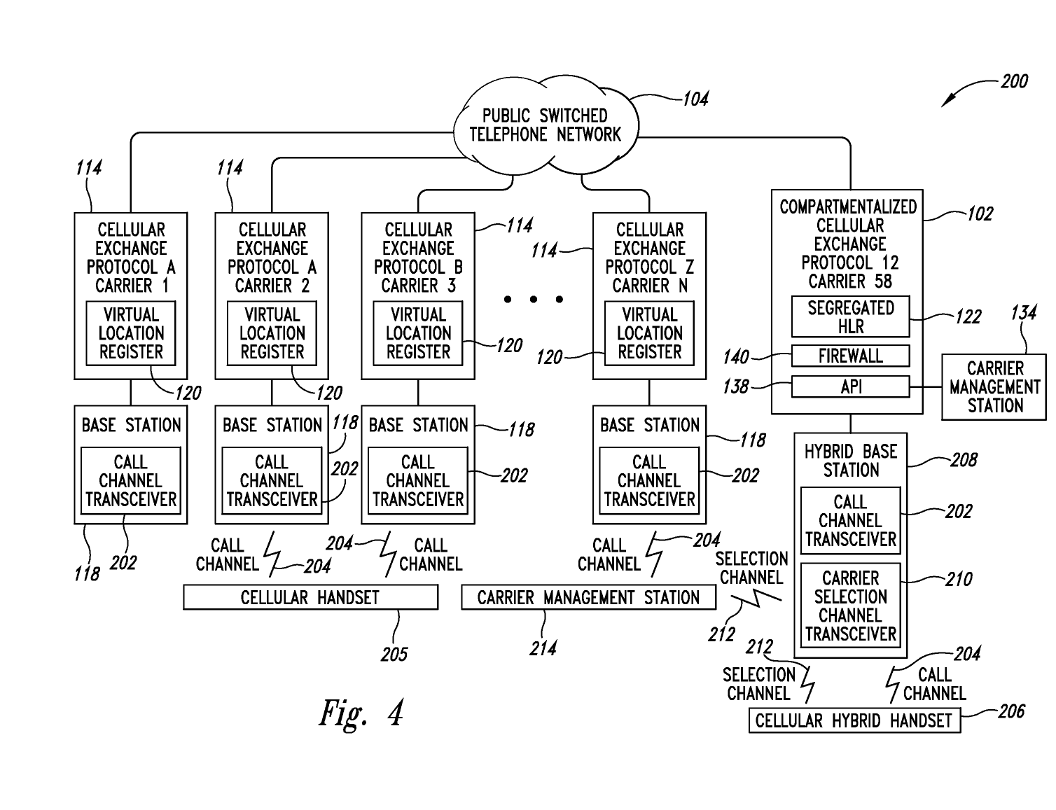

A depicted implementation 200 is shown in FIG. 4 as having a plurality of the cellular exchanges 114 each with the VLR 120 and communicatively linked to the base station 118, each having a call channel transceiver 202. Each of the call channel transceivers 202 is configured to transmit both control signals and media over a wireless call channel such as a cellular call channel 204. A cellular handset 205 is shown communicating via the call channel 204. Further linked to the PSTN 104 is a cellular version of the compartmentalized exchange 102 with a carrier management station as one of the application servers 134.

The compartmentalized exchange 102 is shown in FIG. 4 as being communicatively linked to a cellular hybrid handset 206 through a hybrid base station 208 including a carrier selection channel transceiver 210, which communicates by a selection channel 212. The cellular hybrid handset 206 is shown communicating through both the call channel 204 and the selection channel 212. A second carrier management station 214 is shown communicating via the call channel 204 and the selection channel 212.

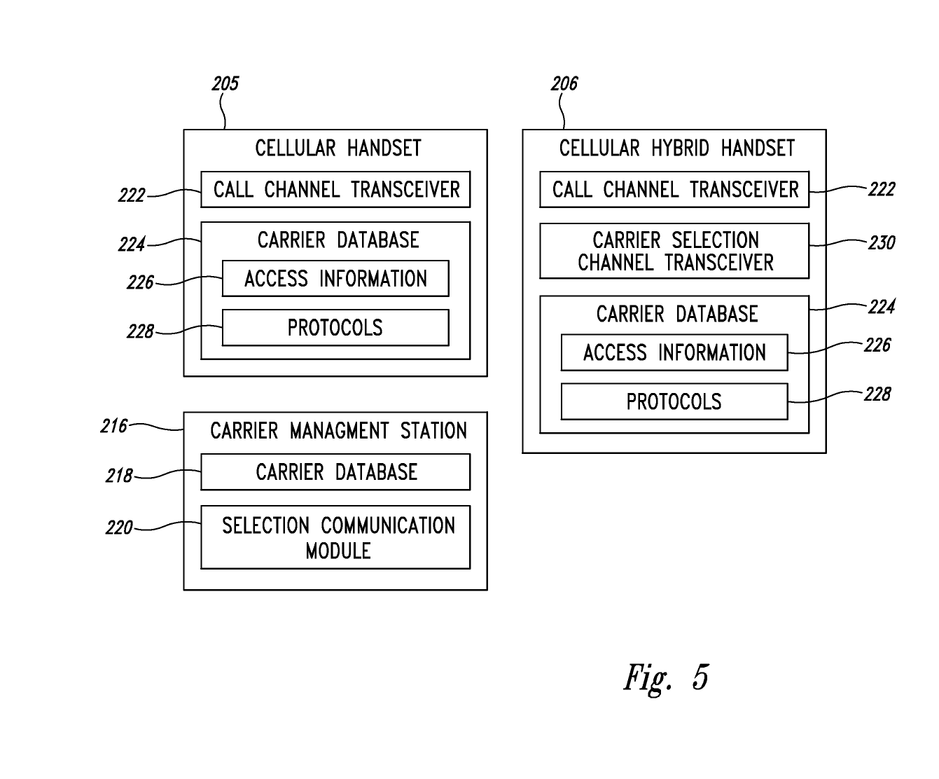

As better shown in FIG. 5, a carrier management station 216, which can represent either the carrier management station 134 and/or the carrier management station 214, includes a carrier database 218 and a selection communication module 220. The carrier database 218 contains selection instructions, updates, and/or full downloads including aspects related to a desired carrier and its associated protocols to be sent as a carrier access selection to the cellular handset 205 and/or the cellular hybrid handset 206 to allow the handsets to be configured to access as the first preferred carrier, the desired carrier associated with one or more of the cellular exchanges 114. The selection communication module 220 can provide selection assistance to a user and subsequently can transmit a carrier selection either through the API layer 138 or through the call channel 204 or the selection channel 212. The selection channel 212 can be a dedicated communication channel to allow transmission of carrier selection and associated instructions, applications, etc to implement a carrier selection on a targeted handset.

The cellular handset 205 and the cellular hybrid handset 206 is shown in FIG. 5 to each include a call channel transceiver 222, and a carrier database 224, which includes access information 226, and protocol information 228. The cellular hybrid handset 206 further includes a carrier selection transceiver 230. The call channel transceiver 222 handles the general control signal and media communication. For the cellular handset 205, the call channel transceiver 222 also receives over the call channel 204 the carrier selection from the one of the carrier management station 134 and the carrier management station 214 whereas for the cellular hybrid handset 206, the carrier selection channel transceiver receives over the selection channel 212 the carrier selection.

The carrier selection is used to update the carrier database 224 as to which of the carriers is the first preferred carrier for handset access. The access information 226 and the protocol information 228 can also be appropriately updated through receipt of the carrier selection. In some implementations, the carrier database 218 and protocol information 220 is used for the preferred one of the cellular exchanges 114 as if the cellular handset 205 or the cellular hybrid handset 206 were in a roaming mode with the preferred carrier being the first position carrier in a roaming list contained in the carrier database 224. A pre-arranged agreement with the selected carrier could typically allow for access by the cellular handset 205 or the cellular hybrid handset 206 of the selected carrier through the VRL 120 of closest of the cellular exchange 114 of the selected carrier. Through the pre-arranged agreement, although access is similar to a roaming cellular handset, the access charges applied by the desired exchange could typically be much lower such as similar to charges incurred if the HRL of the desired carrier was used instead.

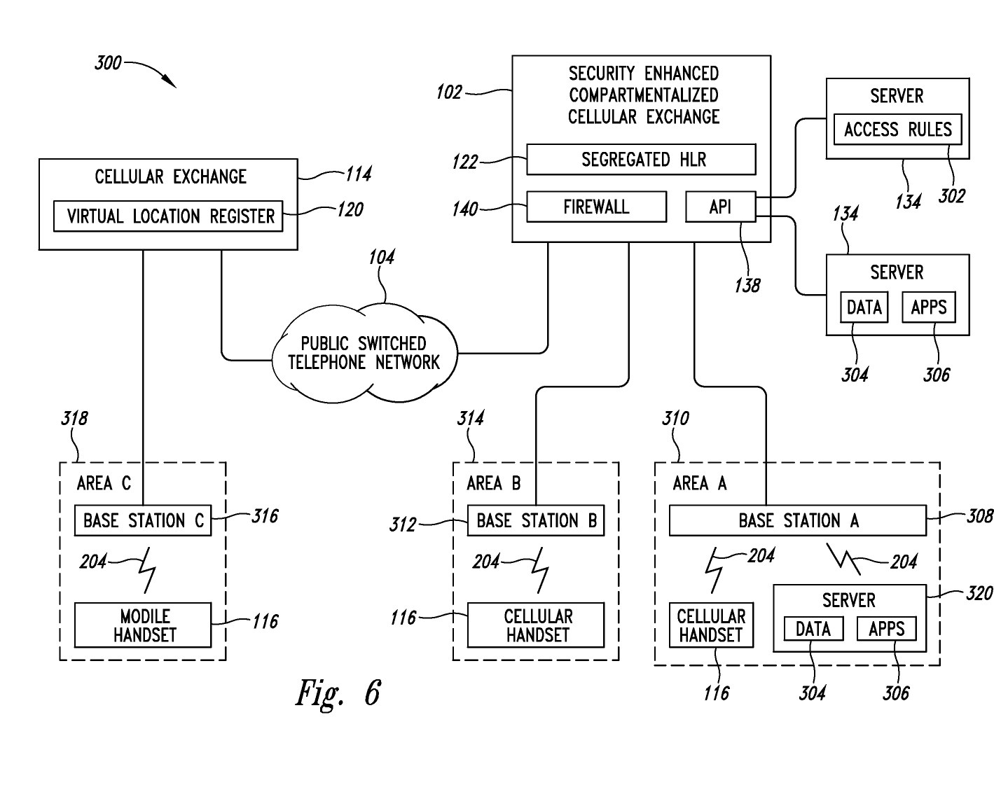

A depicted implementation 300 is shown in FIG. 6 as including one of the application servers 134 having access rules 302 implemented with one of the applications 142. Another one of the application servers 134 is depicted as having data 304 and applications 306 as additional of the applications 142. The compartmentalized cellular exchange 102 is shown communicatively linked to a base station A 308 serving an area A 310 and communicatively linked to a based station B 312 serving an area B 314. A base station C 316 is shown communicatively linked to the cellular exchange 114 to serve an area C 318. A server 320 having the data 304 and the applications 306 is shown to be communicatively linked to the compartmentalized cellular exchange 102 through the base station A 308 and the call channel 204.

The access rules 302 can be used by the compartmentalized cellular exchange 102 to limit access to the data 304 and the applications 306 by the cellular handset 116 depending upon identification of the cellular handset 116 (which can be related to a person who is authorized to use the handset), identification and authentication of an authorized user of the cellular handset, the type of the data and/or the applications requested by the cellular handset, and which of the areas with their associated base stations is the cellular handset is located in at the time of the request.

Implementations generally relate to technology involved with integrated wireless, wire line and Internet protocol (IP) data communications. Implementations include an open platform approach interconnected with wireless, wire line and/or data systems and the PSTN that, for instance, can provide third party non-carrier call control and data integration control of voice and data over all networks including over voice networks (wireless, wire line and IP) interconnected with the PSTN. Such an open platform can provide for application programming interfaces (APIs) that allow for ready access and ready data integration only limited by systems, processes and firewalls that would avoid the introduction of viruses and applications that would compromise the integrity of the network. Such a platform would also allow for the development by non-carrier third parties of API's for integrated application and service provisioning and call control. Such call control would include the ability of third parties to move calls from one network to another using web or wireless web interfaces or voice commands and for the integration of data and data related applications and third party on demand delivery of integrated voice and data and services, including software as a service integrated with voice and data call control over the network or networks chosen by such third party previously or on an ad hoc basis.

Implementations can include open platforms that allow third party non-carrier companies or individuals to control the following over a carrier switching facility. With this implementation the path and delivery of a voice call and/or data transmission can be over a wireless, wire line or data network from a carrier owned switch or switching point or through a carrier owned switch or switching point. The path and delivery of a voice call and/or data transmission coupled with on-demand services, includes but is not limited to software as an on-demand service, over a wireless, wire line or data network from a carrier owned switch or switching point or through a carrier owned switch or switching point. The path and delivery of a voice call and/or a data transmission over a wireless, wire line or data network or any combination of same can be from a common switching point or a carrier owned switch or switching point without requiring call forwarding from a carrier. The path and delivery of a voice call and/or data transmission over a wireless, wire line or data network can be through or from a carrier owned switch or switching point using pre-determined criteria or protocols or on an ad hoc basis.

Implementations can have an open platform that allows third party non-carrier companies or individuals to control through an open interface to a carrier network the path of a voice call and/or data transmission to end-users using one or more of the following:
A wireless device using a wide area wireless data network.
A wireless device using a WiFi network.
A wireless device using a WiMax network.
A wireless device using any wireless network interface
A wireless device enabled to use or using any combination of the foregoing.
Any device connected to the internet.
A wireless or wire line device allowing for integrated voice commands for call control and/or call path determination.

Implementations can include the provisioning at a carrier switch or switching site of a server owned or controlled by a non-carrier that allows control by the non-carrier of non-carrier determined and controlled applications and application interfaces for the provisioning of services through and with the carrier switch.

Implementations can include the placement and integration with a carrier switch at a carrier switching site of a server owned or controlled by a non-carrier and with control by the non-carrier of one or more of the following:
On demand software services integrated with one or more of wireless, wire line or IP telecommunications.
Software as a service integrated with one or more of wireless, wire line or IP telecommunications.
End-user applications and services delivered through a carrier switch over one or more of wireless, wire line or IP networks subject to call control and service configuration by a non-carrier remotely or through a server in the carrier switch or on site at the carrier switch owned or controlled by the non-carrier.
The establishment of interfaces and protocols that will allow the non-carrier to use the transmission paths of the carrier for uses as determined by the non carrier in conjunction with the supply to end-users of services designed and configured and under the control of the non-carrier.
The design and initiation of services using the carrier switching platform as determined by the non-carrier.

Implementations can provide for placement and integration with a carrier switch at a carrier switching site of a server owned or controlled by a non-carrier and with control by the non-carrier through a wireless device of the following:
The delivery of a data interface to a wireless device over a wireless data stream that would allow for non-carrier call control for switching of calls, data transmissions and/or software services over one or more delivery paths including over one or more of wireless, wire line or IP delivery paths.
The use of a non-carrier controlled wireless, wire line or IP data interface that allows for the end-user to choose receipt of a call, the re-direction of a call to a land-line or other phone or the re-direction of the call to one or more delivery paths including over one or more of wireless, wire line or IP delivery paths,the re-direction of a call to one or more voice mailboxes, the delivery of a call to a third party with or without handling or response instructions and to take such other actions with respect to the call as may be provided for or allowed by the interface.
The use of a non-carrier controlled wireless, wire line or IP data interface that allows for the end-user to choose receipt of a data transmission, the re-direction of a data transmission to a land-line or other phone or the re-direction of the data transmission to one or more delivery paths including over one or more of wireless, wire line or IP delivery paths, the re-direction or delivery of a data transmission to a third party with or without handling or response instructions and to take such other actions with respect to the data transmission as may be provided for or allowed by the interface.
The use of a non-carrier controlled wireless, wire line or IP data interface that allows for the end-user to choose receipt of an integrated call and software application or service, the re-direction of the integrated call and software application or service a land-line or other phone or the re-direction of the integrated call and software application or service to one or more delivery paths including over one or more of wireless, wire line or IP delivery paths,the re-direction of an integrated call and software application to one or more voice or data mailboxes, the delivery of an integrated call and software application to a third party with or without handling or response instructions and to take such other actions with respect to the integrated call and software application as may be provided for or allowed by the interface.

Implementations can provide the ability of a third party non-carrier company to integrate telecommunications services and applications using API's developed and controlled by such third party.

Implementations can provide the ability of a third party non-carrier company to integrate telecommunications services and applications to defined market segments such as health care, financial services and others and to control over the carrier networks the delivery of such services.

Implementations can provide an ability of a third party non-carrier company or individual to access the SS7 or other telecommunications or data command and control networks directly using non-carrier developed and controlled API's and software programming.

Implementations can provide provisioning by non-carrier companies and individuals of integrated call control with on-demand software delivery and/or software as a service delivery integrated with telecommunication services.

Implementations can use a dedicated wireless channel to deliver a data interface on a wireless device over a data stream to allow for call control, including but not limited to, the receipt of a call, the re-direction of a call to a wireless network of choice, land-line or other phone, the re-direction of a call to one or more voice mailboxes, the delivery of a call to a third party with or without handling or response instructions and other call control activities provided by or over such a dedicated channel.

Implementations can provide for software, integrated communication protocols and interoperable chip-sets, including but not limited to ASIC chip sets, to optimize data acquisition and transmission and Call Control.

Implementations can use a call control wireless channel to interface with network access and availability information available to the end-user wireless device with call control wireless channel access and/or network access and availability information available from carrier network and network accessible information and resources to determine available and optimal pathways for call or data transmission delivery and to provide for execution by end-user of end-users choice of network delivery either from pre-determined protocols or on an ad hoc basis.

Implementations incorporate approaches to include non-carrier call control at the carrier switching level by enterprises and applications developers and disaggregation of switching from media and the development and opening up of access to a separate call control channel by enterprises and applications developers.

Implementations allow enterprise and applications developer call control, which involves approaches different from how a licensed telecommunications carrier relates to its customers. Carriers have unique status because they are licensed by the state as a local exchange carrier (LEC) or a competitive local exchange carrier (CLEC) or they are licensed by the FCC as a wireless carrier. Carriers have certain key rights and assume certain key responsibilities described as follows.

Rights of a carrier include numbering access—this is the right to obtain numbers from applicable numbering administrators to be listed in the carrier routing guide for the routing of calls between carriers, interconnection—this is the right to be interconnected with other carriers and to require other carriers to terminate calls, and signaling—this is the right to be a peer with other carriers on the signaling network (i.e. SS7) and to deliver call set up and tear down information over that network as well as deliver information over this network for additional and ancillary purposes (i.e. SMS messaging).

Responsibilities of a carrier include emergency call routing—a carrier is required to accept and route 911 or E911 calls to public safety answering points (PSAPs), wiretap subpoena compliance—a carrier is required to comply with law enforcement acts and to implement wiretaps when a subpoena is issued, and acceptance of signaling and termination of other carrier calls—this includes the acceptance of calls (and signaling) of other carriers and termination of those calls.

Rights of a carrier allow capabilities that large enterprises would like to have access to. A desire that has increased dramatically with the increasingly rapid movement of telecommunications at the enterprise level to an all Internet Protocol (IP) architecture under which voice becomes an application on a data network. In addition, developers of end-user applications and services for enterprises and other end-users would like direct access to these capabilities for the development of integrated services.

Yet, neither enterprises nor applications developers want to take on the responsibilities of a carrier including, in particular, 911 and legal act obligations. In addition, most of the members of these groups do not want to engage in and assume the state by state regulatory requirements to become a CLEC or expend the large sums required to acquire the spectrum and network elements required to become a wireless carrier.

Current carriers are resistant to the idea of becoming simply transport platforms and, in part because of this resistance, avoid giving call control access to their customers. An open call control platform and APIs for direct third party call control contemplated herein is unique and not previously developed or contemplated.

Accordingly, the platform and platform architecture of implementations provide to enterprises and application developers access to the capabilities of a carrier to provide, among other things, one or more of the following:
Direct development of services and applications on a carrier network otherwise unavailable to enterprises and applications and services developers.
Integration of applications and services developed on non-carrier platforms and networks into and with a carrier network, services and signaling platform.
Direct access by enterprises or applications developers to a pre-defined block of numbers on the carrier network allowing for the direct provisioning, management and de-provisioning of access and of defined services and applications by identified end-users.
Direct management of service delivery and integrated services and applications by enterprise developed and controlled business rules and service components
Real-time call detail record (CDR) delivery and data management and data mining.

What the carrier does in order to facilitate the foregoing is provide unique access, capabilities and elements to enterprises and applications developers at the carrier level. Elements involved with implementations of platform configurations and capabilities include the following:
A core switching architecture that will allow direct control over certain carrier switching functions previously protected and controlled by the carrier
Separate (“blade”) servers at the carrier switch and accessible by enterprises that will be populated with numbers and have application programming interfaces (APIs) that will allow for:
   The provisioning and de-provisioning of numbers by direct enterprise action.
   The application of business rules developed and controlled by enterprises to the end-users using numbers and available services for those numbers controlled by the enterprise and its business rules.
   The development of enterprise specific applications and services incorporated with the carrier network for its employees.
   The development of enterprise specific applications and services incorporated with the carrier network for its vendors and supply chain.
   The deployment of wireless services on licensed spectrum at the enterprise integrated with the enterprises IP-PBX.
   The direct development of wireless and wireline integrated applications and services with direct control over the carrier portion of the network for the delivery of these services.
Separate (“blade”) servers at the carrier switch and accessible by applications and service developers that will be provided APIs that will allow for:
   Direct integrated programming of services and applications using the carrier switching platform for the delivery of application and service provider media to end-users:
      On the carrier network
      By delivery through other carrier networks
   Direct integrated programming of services and applications using the carrier switching platform for the delivery of application and service provider signaling for the delivery of services to end-users:
      On the carrier network
      By delivery over other carrier networks.
A “firewall” between the enterprise and application developer accessible servers and the core switching functions of the switch so that:
   The actions of one enterprise or applications developer will not compromise the integrity and service capability of others using similar blade servers to control and provide service.
   Assurance can be provided that the core carrier obligations (i.e. 911 and CALEA) and numbering reporting and termination requirements are met.
   The placement of data control in the enterprise for on-site control by enterprises of data, applications and services.

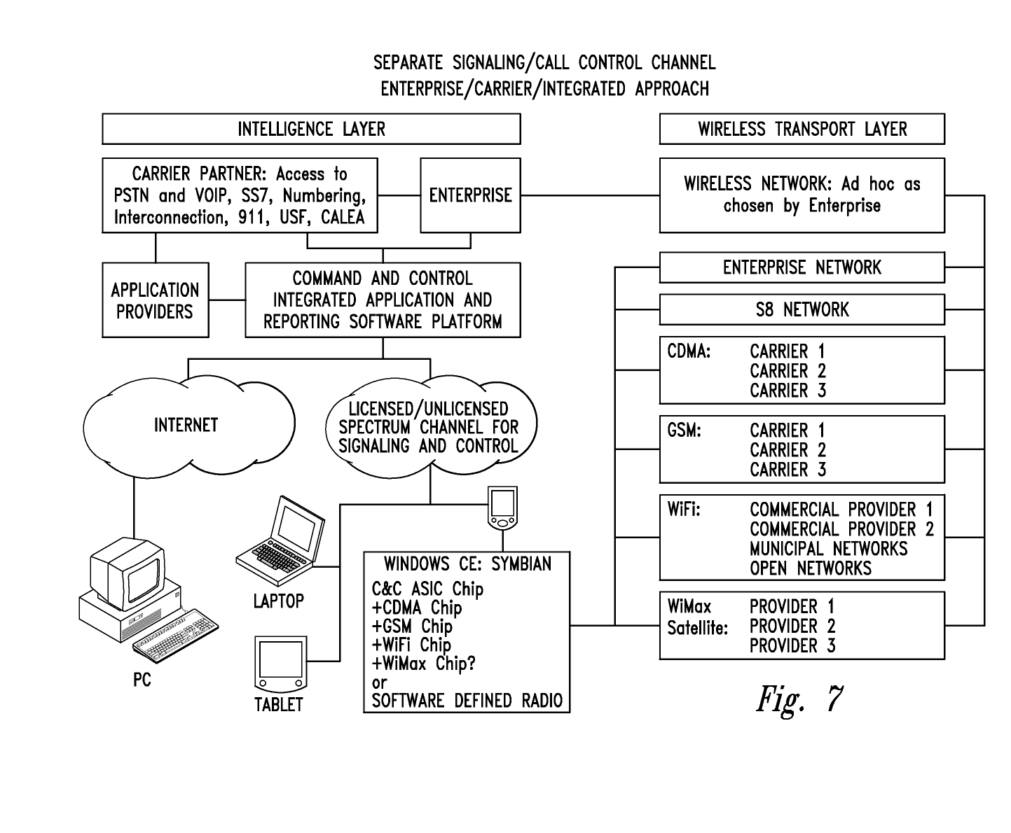

Implementations can involve disaggregated switching and media wherein in addition to the development of an open carrier switching platform a network architecture is provided to disaggregate signaling from flow of voice, data and media as shown in FIG. 7.

In one or more various implementations, related systems include but are not limited to circuitry and/or programming for effecting the foregoing-referenced method implementations; the circuitry and/or programming can be virtually any combination of hardware, software, and/or firmware configured to effect the foregoing-referenced method implementations depending upon the design choices of the system designer.

The descriptions are summaries and thus contain, by necessity; simplifications, generalizations and omissions of detail; consequently, those skilled in the art will appreciate that the summaries are illustrative only and are not intended to be in any way limiting. Other aspects, inventive features, and advantages of the devices and/or processes described herein, as defined solely by the claims, will become apparent with respect to the non-limiting detailed description set forth herein.

Those having ordinary skill in the art will also appreciate that although only a number of server applications are shown, any number of server applications running on one or more server computer could be present (e.g., redundant and/or distributed systems could be maintained). Lastly, those having ordinary skill in the art will recognize that the environment depicted has been kept simple for sake of conceptual clarity, and hence is not intended to be limiting.

Those having ordinary skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having ordinary skill in the art will appreciate that there are various vehicles by which processes and/or systems described herein can be effected (e.g., hardware, software, and/or firmware), and that the preferred vehicle will vary with the context in which the processes are deployed.

For example, if an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

The detailed description has set forth various embodiments of the devices and/or processes via the use of block diagrams, flowcharts, and examples. Insofar as such block diagrams, flowcharts, and examples contain one or more functions and/or operations, it will be understood as notorious by those within the art that each function and/or operation within such block diagrams, flowcharts, or examples can be implemented, individually and/or collectively, by a wide range of hardware, software, firmware, or virtually any combination thereof.

From the foregoing it will be appreciated that, although specific embodiments of the invention have been described herein for purposes of illustration, various modifications may be made without deviating from the spirit and scope of the invention. Accordingly, the invention is not limited except as by the appended claims.

The invention claimed is:

1. A system comprising:
a communication exchange having a home location register including a plurality of number profiles, a first portion of the number profiles constituting a first number set and a second portion of the number profiles constituting a second number set;
an application server communicatively linked with the communication exchange, the application server including a plurality of server applications, a first portion of the plurality of server applications constituting a first application set and a second portion of the plurality of server applications constituting a second application set, the application server configured to allow access for a first user to the first application set and to prevent access for the first user to the second application set, the application server configured to allow access for a second user to the second application set and to prevent access for the second user to the first application set; and
a segregator layer configured to maintain association between the first number set with the first application set, to prevent association between the first number set and the second application set, to maintain association between the second number set with the second application set, and to prevent association between the second number set and the first application set.

2. The system of claim 1 wherein the number profiles include at least one of authorization information, authentication information, privilege information, responsibility information, rights information, user identification, and handset identification related to a handset.

3. The system of claim 1 wherein the server applications include at least one of a database, and voice call activation and commands.

4. The system of claim 1 wherein the segregator layer is communicatively linked between the application server and the communication exchange.

5. The system of claim 1 wherein a third portion of the plurality of server applications constitutes a third application set and the segregator layer is configured to maintain association between the third application set and the first number set and to maintain association between the third application set and the second number set.

6. The system of claim 1 wherein association between one of the number sets with one of the application sets includes management control by at least one of the applications of the application set of the number profiles of the number set.

7. The system of claim 6 wherein the management control includes assigning a number profile to a handset.

8. The system of claim 1 wherein association between one of the number sets with one of the application sets includes at least one of the applications of the application set sending data to at least one handset having one of the number profile of the number set.

9. A system comprising:
a communication exchange having a home location register including a plurality of number profiles, a first portion of the number profiles constituting a first number set and a second portion of the number profiles constituting a second number set;
a first application server communicatively linked with the communication exchange, the first application server having a first plurality of server applications constituting a first application set, the first application server configured to allow access for a first user to the first application set and to prevent access for a second user to the first application set;
a second application server communicatively linked with the communication exchange, the second application server having a second plurality of server applications constituting a second application set, the second application server configured to allow access for the second user to the second application set and to prevent access for the first user to the second application set; and
a segregator layer configured to maintain association between the first number set with the first application set, to prevent association between the first number set and the second application set, to maintain association between the second number set with the second application set, and to prevent association between the second number set and the first application set.

10. A system comprising:
a communication exchange having a home location register including a plurality of number profiles, a first portion of the number profiles constituting a first number set and a second portion of the number profiles constituting a second number set;
a first application server communicatively linked with the communication exchange, the first application server having a first plurality of server applications constituting a first application set, the first application server configured to allow access for a first user to the first application set and to prevent access for a second user to the first application set;
a second application server communicatively linked with the communication exchange, the second application server having a second plurality of server applications constituting a second application set, the second application server configured to allow access for the second user to the second application set and to prevent access for the first user to the second application set; and
a segregator layer configured to maintain association between the first number set with the first application set to allow interaction between a handset having a number profile of the first number set with a server application of the first application set, to prevent association between the first number set and the second application set to prevent interaction between any handset having a number profile of the first number set with a server application of the second application set, to maintain association between the second number set with the second application set to allow interaction between a handset having a number profile of the second number set with a server application of the second application set, and to prevent association between the second number set and the first application set to prevent interaction between any handset having a number profile of the second number set with a server application of the first application set.

11. A system comprising:
a communication exchange having a home location register including a plurality of number profiles, a first portion of the number profiles constituting a first number set and a second portion of the number profiles constituting a second number set;
a first application server communicatively linked with the communication exchange, the first application server having a first plurality of server applications constituting a first application set, the first application server configured to allow access for a first user to the first application set and to prevent access for a second user to the first application set;
a second application server communicatively linked with the communication exchange, the second application server having a second plurality of server applications constituting a second application set, the second application server configured to allow access for the second user to the second application set and to prevent access for the first user to the second application set; and
a segregator layer configured to maintain association between the first number set with the first application set to allow management of the number profiles of the first number set by a server application of the first application set, to prevent management of the number profiles of the first number set by any of the server applications of the second application set, to maintain association between the second number set with the second application set to allow management of the number profiles of the second number set by a server application of the second application set, and to prevent association between the second number set and the first application set to prevent management of the number profiles of the second number set by any of the server applications of the first application set.

12. A system comprising:
a communication exchange having a home location register including a plurality of number profiles, a first portion of the number profiles constituting a first number set;
at least one application server communicatively linked with the communication exchange, the at least one application server including a plurality of server applications, a first portion of the plurality of server applications constituting a first application set and a second portion of the plurality of server applications constituting a second application set, the at least one application server configured to allow access for a first user to the first application set and to prevent access for the first user to the second application set, the at least one application server configured to allow access for a second user to the second application set and to prevent access for the second user to the first application set; and
a segregator layer configured to maintain association between the first number set with the first application set, to prevent association between the first number set and the second application set.

13. A system comprising:
a communication exchange having a home location register including a plurality of number profiles, a first portion of the number profiles constituting a first number set and a second portion of the number profiles constituting a second number set;
at least one application server communicatively linked with the communication exchange, the at least one application server including a plurality of server applications, a first portion of the plurality of server applications constituting a first application set, the at least one application server configured to allow access for a first user to the first application set and to prevent access for a second user to the first application set; and
a segregator layer configured to maintain association between the first number set with the first application set, and to prevent association between the second number set and the first application set.

14. A method comprising:
providing a home location register including a plurality of number profiles,;
segregating a first portion of the number profiles into a first number set;
segregating a second portion of the number profiles into a second number set;
segregating a first portion of a plurality of server applications into a first application set;
segregating a second portion of the plurality of server applications into a second application set;
allowing access for a first user to the first application set;
denying access for the first user to the second application set;
allowing access for a second user to the second application set;
denying access for the second user to the first application set;
maintaining association between the first number set with the first application set;
preventing association between the first number set and the second application set;
maintaining association between the second number set with the second application set; and
preventing association between the second number set and the first application set.

15. The method of claim 14 wherein the number profiles include at least one of authorization information, authentication information, privilege information, responsibility information, rights information, user identification, and handset identification related to a handset.

16. The method of claim 14 wherein the server applications include at least one of a database, and voice call activation and commands.

17. The method of claim 14 wherein the preventing association occurs between an application server and a communication exchange containing the home location register.

18. The method of claim 14 further including segregating a third portion of the plurality of server applications into a third application set; maintaining association between the third application set and the first number set; and maintaining association between the third application set and the second number set.

19. The method of claim 14 wherein association between one of the number sets with one of the application sets includes management control by at least one of the applications of the application set of the number profiles of the number set.

20. The method of claim 19 wherein the management control includes assigning a number profile to a handset.

21. The method of claim 14 wherein association between one of the number sets with one of the application sets includes at least one of the applications of the application set sending data to at least one handset having one of the number profile of the number set.

22. A method comprising:
providing a home location register including a plurality of number profiles;
segregating a first portion of the number profiles into a first number set;
segregating a second portion of the number profiles into a second number set;
segregating a first plurality of server applications into a first application set;
allowing access for a first user to the first application set;
preventing access for a second user to the first application set;
segregating a second plurality of server applications into a second application set;
allowing access for the second user to the second application set;
preventing access for the first user to the second application set; and
maintaining association between the first number set with the first application set to allow interaction between a handset having a number profile of the first number set with a server application of the first application set;
preventing association between the first number set and the second application set to prevent interaction between any handset having a number profile of the first number set with a server application of the second application set;
maintaining association between the second number set with the second application set to allow interaction between a handset having a number profile of the second number set with a server application of the second application set; and
preventing association between the second number set and the first application set to prevent interaction between any handset having a number profile of the second number set with a server application of the first application set.

23. A method comprising:
providing a home location register including a plurality of number profiles;
segregating a first portion of the number profiles into a first number set;
segregating a second portion of the number profiles into a second number set;
segregating a first plurality of server applications into a first application set;
allowing access for a first user to the first application set;
preventing access for a second user to the first application set;
segregating a second plurality of server applications into a second application set;
allowing access for the second user to the second application set;
preventing access for the first user to the second application set;
maintaining association between the first number set with the first application set to allow management of the number profiles of the first number set by a server application of the first application set;
preventing management of the number profiles of the first number set by any of the server applications of the second application set;
maintaining association between the second number set with the second application set to allow management of the number profiles of the second number set by a server application of the second application set; and
preventing association between the second number set and the first application set to prevent management of the number profiles of the second number set by any of the server applications of the first application set.

24. A method comprising:
providing a home location register including a plurality of number profiles;
segregating a first portion of the number profiles into a first number set;
segregating a first portion of a plurality of server applications into a first application set;
segregating a second portion of the plurality of server applications into a second application set;
allowing access for a first user to the first application set;
preventing access for the first user to the second application set;
allowing access for a second user to the second application set;
preventing access for the second user to the first application set;
maintaining association between the first number set with the first application set; and
preventing association between the first number set and the second application set.

25. A method comprising:
providing a home location register including a plurality of number profiles;
segregating a first portion of the number profiles into a first number set;
segregating a second portion of the number profiles constituting a second number set;
segregating a first portion of a plurality of server applications into a first application set;
allowing access for a first user to the first application set;
preventing access for a second user to the first application set;
maintaining association between the first number set with the first application set; and
preventing association between the second number set and the first application set.
